(19) United States
(12) Patent Application Publication
(10) Pub. No.: US 2009/0194364 A1
(43) Pub. Date: Aug. 6, 2009

(54) MUFFLERS WITH POLYMERIC BODIES AND PROCESS FOR MANUFACTURING SAME

(75) Inventors: Philippe Leboeuf, St. Maurice (FR); Frederic Bonnin, Alfortville (FR); Karl Paul Maurer, North Branch, MN (US); Daniel P. Jones, Royal Oak, MI (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I.DU PONT DE NEMOURS AND COMPANY

(21) Appl. No.: 12/363,884

(22) Filed: Feb. 2, 2009

Related U.S. Application Data
(60) Provisional application No. 61/063,351, filed on Feb. 1, 2008.
(60) Provisional application No. 61/063,408, filed on Feb. 1, 2008.

(51) Int. Cl. F01N 1/00; B23P 17/00

(52) U.S. Cl. 181/247; 29/890.08

(57) ABSTRACT

Mufflers having polymeric bodies that are protected from being overheated from the exhaust pipe by having an air gap between the exhaust pipe and the polymeric body are disclosed. Also disclosed is a process for making muffler systems wherein the muffler polymeric bodies have a cross section that is constant over the length of the muffler polymeric body. The muffler systems are inexpensive to make and install.

### FIELD OF THE INVENTION

Mufflers have polymeric bodies which have an air gap between the polymeric body and the exhaust pipe at and/or near their mounting points to the exhaust pipe is disclosed as well as a process for manufacturing muffler systems by extrusion of polymeric muffler bodies.

### TECHNICAL BACKGROUND

Mufflers (also called silencers) are used as part of exhaust systems of internal combustion and other types of engines, principally to reduce the noise exiting the engine with the exhaust gases (except perhaps in jet and rocket engines). Typical types of uses for these systems are on automobiles, trucks, snowmobiles, motorcycles, boats, scooters, railroad engines, electrical generators, golf carts, tractors and other motorized agricultural equipment, lawn mowers and other power landscaping equipment, etc. Virtually any use for an internal combustion engine usually also includes a muffler (system). Because of the high temperatures of the exhaust gases, and the corrosive nature of those gases, metals, particularly steel, have traditionally been used for mufflers. Corrosion is a problem with these metals, but that has partially been solved by using more expensive alloys such as stainless steel. Nevertheless mufflers have tended to be bulky (needed to reduce the noise sufficiently), and heavy because of the high density of metals.

More recently it has been proposed to use mufflers in which the muffler body is a polymer with good high temperature resistance, see for instance U.S. Pat. Nos. 5,321,214, 5,340,952 and 5,052,513, 6,543,577 and European Patent 446,064. However mounting these mufflers onto an exhaust pipe has proved problematical, since the exhaust pipe may reach very high temporaries (>400° C. in certain designs and/or under certain operating conditions), which has caused the melting and/or degradation of the polymeric muffler and or its mounts. For instance the polymeric bushings described in U.S. Pat. No. 6,543,577 often degrade because of heating by the exhaust pipe.

One method used to reduce the high temperatures to which the polymeric are exposed is to use an insulated gap between the muffler body and the exhaust pipe, see for instance U.S. Pat. Nos. 5,321,952 and 5,340,952. However the design of the mounting for these mufflers is cumbersome, involving multiple parts and/or not allowing for easy attachment and/or removal of the muffler body, and requiring the use of insulation. Therefore improved designs for mufflers are needed.

### SUMMARY OF THE INVENTION

One aspect of the invention is a muffler system, comprising a metal exhaust pipe attached to and passing through a first body mounting adapter, and attached to and passing through a second body mounting adapter; between said first and second mounting adapter said metal exhaust pipe being encased by a polymeric muffler body attached to the said first and second body mounting adapters to provide a muffler interior, said muffler interior having an air gap, said air gap being a space in between said exhaust pipe and said polymeric muffler body in the vicinity of said first body mounting adapter and/or said second body mounting adapter that is filled with air, and said first body mounting adapter and said second mounting adapter hold said polymeric body a distance from said exhaust pipe so that said polymeric muffler body does not suffer significant thermal damage during operation of said muffler system.

Another aspect of the invention is a process for manufacture of a muffler system, comprising, a polymeric muffler body, a metal exhaust pipe, a first body mounting adapter, and a second body mounting adapter, wherein said first body mounting adapter and said second mounting adapter hold said polymeric muffler body a distance from said exhaust pipe so that said polymeric muffler body does not suffer significant thermal damage during operation of said muffler system; comprising:

melt extruding a polymeric material to provide an extrudate; and

cutting the extrudate to provide a length of a polymeric muffler body having a cross section; said cross section being constant over said polymeric muffler body length.

### BRIEF DESCRIPTION OF THE FIGURES

FIG. 1 shows a plan view of a typical muffler of the present invention.

FIGS. 2A-2C show details, in cross section, of attaching the polymeric muffler body and exhaust pipe to a mounting adapter to form a muffler system.

FIG. 3 shows the cross section of polymeric muffler body, the body having different thicknesses in different parts of the cross section.

### DETAILS OF THE INVENTION

Herein certain terms are used and they are defined below:

By a “first mounting adapter” is meant an adapter which holds the muffler body in position relative to the exhaust pipe, and is on the end of the muffler closest to the engine.

By a “second mounting adapter” is meant an adapter which holds the muffler body in position relative to the exhaust pipe, and is on the end of the muffler furthest away from the engine.

By “attached to” in regards to the polymeric muffler body to the first and second mounting adapters and/or the adapters to the exhaust pipe, means fixedly attached. By “fixedly” means that in normal operation the item will not move in relationship to the item to which it is attached, but may be removable, for example, for repair or replacement.

By a “polymeric muffler body” is meant a muffler having a body (casing) made of a polymeric material, which may be any kind of polymer, including a thermoplastic, thermoset, or an infusible polymer (polymer is not crosslinked but does not become liquid before it reaches it decomposition temperature).

By “polymeric” is meant a composition comprising a polymer and optionally containing any other materials usually found in such compositions such as fillers, reinforcing agents, stabilizers, pigments, antioxidants, and lubricants. It includes both thermoset and thermoplastic polymeric materials.

By an “air gap” is meant a volume filled with air, and does not contain (in the volume of the named air gap) other insulating materials such as glass, ceramic or rock wool fibers, or a very low density ceramic foam. However other interior portions of the polymeric body (not the air gaps) may contain such insulators.

By “significant thermal damage” is meant that the polymeric muffler body will not suffer damage due to high temperatures that would render it unfit for normal use. The minimum period of time this damage would not be suffered would be determined by the equipment manufacturers specifications, but typically would be more than about 1000 hours, more preferably more than about 2000 hours, especially preferably more than about 3000 hours, and very preferably more than about 5000 hours of “normal” operation.

“In the vicinity of” in relationship to the distance of the air gap longitudinally along the exhaust pipe preferably means the air gap extends at least 1 cm from mounting point of the first and/or second body mounting adapter(s) measured from their contact point with the exhaust pipe, this contact point being on the extremity of such contact on the interior portion of the muffler. Preferably this distance is at least about 1.5 cm, more preferably at least about 2.0 cm, and very preferably at least about 3.0 cm. The air gap volume in these spaces is measured away from the exhaust pipe by drawing a perpendicular from the longitudinal axis exhaust pipe where the pipe contacts the first and/or second body mounting adapter(s).

One embodiment is a muffler system, as disclosed above wherein said air gap extends at least 1 cm from said first and second body mounting adapters.

The polymer (of the polymeric muffler body) should be temperature resistant enough to withstand temperatures that it may be heated to. Usually the hottest part of this section of the exhaust system will be the exhaust pipe at the first mounting adapter and the polymer there should be able to withstand temperatures generated when the exhaust pipe is hot (unless a section of polymeric muffler body is closer to the exhaust pipe than the body is in the vicinity of the first and/or second body mounting adapters causing that section to be hotter). Engine and automotive vehicle manufacturers generally have specifications or standards for any particular engine and exhaust system configuration in which the temperature of the exhaust pipe at the muffler inlet portion will be known or specified.

Mufflers with polymeric bodies are known. Useful materials for these polymeric bodies include thermoplastics such as polyamides such as nylon-6,6, nylon 6, and partially aromatic polyamides, thermotropic liquid crystalline polymers, higher melting polyesters, polyacetals, poly(arylene sulfides), polyketones, poly(etherketones), poly(etheretherketones), and thermosetting resins such as epoxy, melamine and phenolic (thermosetting) resins, and infusible polymers such as polyimides, poly(p-phenylenes), and polymers composed mostly or all of repeat groups of the formula

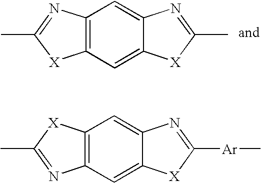

wherein X is NH, N-Phenyl, O (oxygen) or S (sulfur), and Ar is p-phenylene, 4,4′-biphenylene or 1,4-naphthylylene. These bodies, as is well known, must be capable of withstanding higher temperatures to which they may be exposed, for example by direct contact with exhaust gases and/or being heated by thermal conduction.

Thermoplastics are preferred types of polymers. Preferred thermoplastics are polyamides, especially partially aromatic polyamides. By partially aromatic polyamides is meant that some, but not all, of the repeat unit in the polyamide contain aromatic rings. Useful partially aromatic polyamides include copolyamides of 1,6-hexanediamine, terephthalic and/or isophthalic acids, and optionally adipic acid, and polyamides derived in whole or part from one or more of the following monomers, H₂N(CH₂)ₘNH₂ wherein m is 4 to 14, HO₂C(CH₂)_{y}CO₂H wherein y is two to 14,2-methyl-1,5-pentanendiamine, isophthalic acid, terephthalic acid, 1,3-diaminobenzene, 1,4-diaminobenzene, and 4,4′-bibenzoic acid.

The interior of the muffler, excluding the air gaps, may be partly or fully filled with an insulating material such as fiberglass, rock wool or other ceramic fibers, Not only do these fibers often assist in deadening the sound, they may also act to improve the thermal isolation of the muffler body from the heat from the exhaust pipe, so it is preferred that these fibers be present. Inside the muffler itself the exhaust pipe may have a plurality of holes in it to improve the sound deadening characteristics of the muffler. Several known polymeric mufflers have one or both of these features, see for instance U.S. Pat. Nos. 5,340,952, 6,543,577 and European Patent Application 446,064, all of which are hereby included by reference.

One embodiment is a muffler system as disclosed above wherein the muffler interior not occupied by the air gap, is partly or fully filled with an insulating material.

The present muffler systems have an “air gap” between the exhaust pipe and the polymeric muffler body. If there were no air gap, the body may be directly attached to the outer surface of the exhaust pipe, which would often result melting and/or degradation of the polymer. However the air gap is in essence thermal insulation, and the larger the distance between the outer surface of the exhaust pipe and inner surface of the inlet or outlet portions, for a given set of conditions (especially exhaust temperature and flow) the lower the temperature to which the polymeric muffler body will be exposed. The necessary length of this distance, to achieve a certain maximum exposure for the polymeric muffler body near the first and/or second mounting adapters may be readily obtained by experimentation or may be calculated (see below) using heat flow finite element analysis. Other secondary considerations for calculating these exposure temperatures are the configuration(s) of and material(s) of construction of the first and second body mounting adapters, any gaskets which may be used, etc. (see below).

The muffler system, for instance the exhaust pipe and/or body mounting adapter(s), may additionally have a hanger or clamp built into it for attachment to some other part of the automotive vehicle or engine assembly, and/or may be clamped in some other manner, for example by strap around the polymeric muffler body, to the rest of the apparatus structure.

The cross section of the polymeric muffler body may vary over the length of the muffler body. The body may be formed by any number of methods, such as injection molding, extrusion, blow molding, rotomolding, reaction injection molding (thermosets especially), and compression molding.

The polymeric muffler body may have a constant cross section, and by having a constant cross section along the length of the polymeric muffler body this body may be melt extruded. After extrusion the extrudate is cut to the length required. Extrusion is a relatively cheap method of forming polymeric, especially thermoplastic, parts, cheaper for example than injection or blow molding which are usually used to make parts with more complicated shapes.

Another embodiment of the invention is a process for manufacture of a muffler system, as disclosed herein, having a constant cross section along the length of the polymeric muffler body comprising:

melt extruding a polymeric material to provide an extrudate; and

cutting the extrudate to provide a length of a polymeric muffler body having a cross section; said cross section being constant over said polymeric muffler body length

The polymeric body is preferably a single part but may be more than one part (usually split longitudinally). For instance the body may be extruded in two halves (preferably split longitudinally) which are joined, perhaps by one or more separate exterior clamps, or the two parts may “snap fit” together, and/or be joined by an adhesive, or be welded together, for instance by laser welding or vibration welding. A sealant may be used to ensure no gas leakage from the joint(s) formed. However since the body must have a constant cross section along its length, if the body is made up of more than one part each of those parts must have the same cross section along its length.

Another embodiment is the process as disclosed above wherein the extruding provides an extrudate having a cross section that is a portion of the cross section of the polymeric muffler body.

Another embodiment is the process as disclosed above wherein the extrudate cross section provides two halves of the polymeric muffler body cross section. These halves may be produced from the same extrudate and attached to provide the complete muffler polymeric body.

The first and second body mounting adapters hold the polymeric muffler body in position relative to the exhaust pipe. Since they typically are in contact with the exhaust pipe they should be made of a material which resists high temperatures, such as metal or ceramic. Metal is preferred for one or both of the body mounting adapters. A body mounting adapter may one or more pieces, for example they may slide onto the exhaust pipe, or be essentially split rings. One piece adapters are preferred. The first and second body mounting adapters may be the same or different design. The body mounting adapters may be attached to the exhaust pipe by a variety of methods, for instance (assuming they are metal) welded, clamped, force fit, bolted or screwed, etc. Since it is usually undesirable to have exhaust gas leaking from between the exhaust pipe and the adapters it may be desirable to use a high temperature mastic or similar material to seal the joint between the exhaust pipe and the adapter(s), particularly if it is not (completely) welded.

The adapters may hold the polymeric muffler body in place by any number of means. For instance a gasket may be used to both hold the body and seal the joint between the adapter and the body. Other mechanical means such as bolts or (sheet metal) screws may also be used. In this case a sealant may be desirable to ensure a gas tight joint. Some of these methods are illustrated in the Figures.

As previously mentioned the adapters hold the polymeric muffler body in position relative to the exhaust pipe. The exhaust pipe need not go through the center (longitudinally) of the polymeric muffler body, it may be off center. The exhaust pipe need not run parallel to the sides of the muffler body but may be, for example, diagonal to the long axis of the muffler body. The exhaust pipe may curve inside the polymeric muffler body, but not be so close at any given point that it will cause the temperature of the polymeric muffler body to get too high. These “differences” in the relative positions of the polymeric muffler body and the exhaust pipe will be determined by the configuration of the adapter(s) and whether or not the exhaust pipe is straight or not. Some of these configurations are illustrated in the Figures.

FIG. 1 shows an exemplary plan view of a muffler system of this invention. Note that the polymeric muffler body 1 is elliptically shaped, and the exhaust pipe 2 is mounted off center in the first and second body mounting adapters, 3 and 4 respectively. Not shown is any detail as to how the body mounting adapters 3 and 4 are connected to the polymeric muffler body 1 and the exhaust pipe 2.

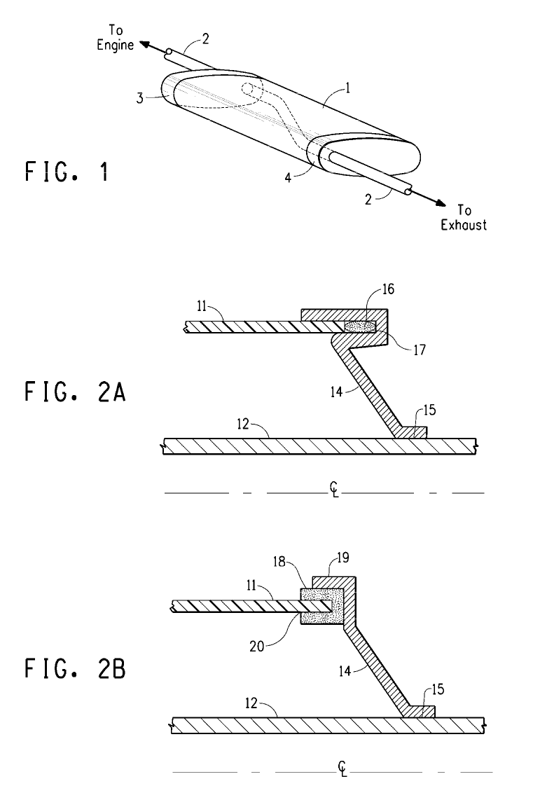

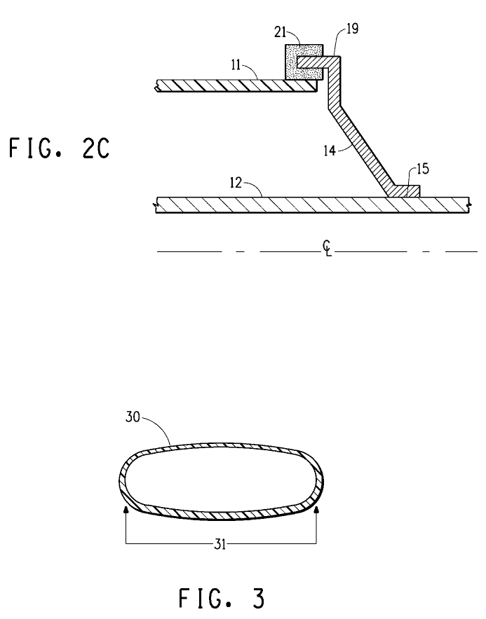

FIGS. 2A, 2B, and 2C show a partial cutaway view through the polymeric muffler body 11, exhaust pipe 12, and second body mounting adapter 14 (it could also be the first body mounting adapter) made of sheet metal. In these FIG. 14 is welded to 12 in area 15. These Figures show possible variations on how to hold and seal the polymeric muffler body to the adapters. In FIG. 2A a gasket or o-ring 16 is fitted into a slot 17 near the outer periphery of 14. To form the seal 11 is pressed against 16 by the adapter at the other end of the muffler. In FIG. 2B gasket 18 is inserted inside the periphery of extension 19 on the periphery of 14, and then polymeric muffler body 11 is pressed into groove 20 of gasket 18. Again to form the seal 11 is pressed into groove 20 by the adapter at the other end of the muffler. In FIG. 2C polymeric muffler body 11 contacts the inner periphery of gasket 21, which in turn is mounted on extension 19 of body mounting adapter 14. Again to form the seal the outer surface of 11 is pressed against the inner surface of 21 by the adapter at the other end of the muffler. In all of FIGS. 2A, 2B, and 2C a sealant and/or adhesive may also be used to help form a gas tight joint between 11 and 14. Indeed in some instances for example in FIG. 2B or 2C the gaskets 20 and 21 respectively may not even be needed, if there is a slight press or interference fit between 11 and the inner surface of 19, especially if a sealer/adhesive is used in the joint.

The distance between the polymeric muffler body and the exhaust pipe in FIG. 2A-2C is the distance between the surfaces of 11 and 12 closest to one another in the vicinity of 14,

The thickness of the polymeric muffler body may vary across the polymeric muffler body cross section. For example in a vehicle it may be an advantageous for the bottom surface of the polymeric muffler body to be thicker than the top surface, since rocks or other road debris may hit the bottom of the muffler system, or may be kicked up by the tires and hit the bottom of the muffler. A cross section of such a polymeric muffler body is shown in FIG. 3. The muffler body 30 is thicker in the bottom section 31.

Another embodiment is a process as disclosed above wherein the polymeric muffler body cross section has a thickness that varies across said cross section.

Muffler systems as shown in FIGS. 1 and 2A-2C may be easily and cheaply assembled. For instance the first or second body mounting adapter is slid down the exhaust pipe into position and attached to the exhaust pipe, for example by welding. If a gasket or o-ring is needed and is not already present it is mounted on/in the attached adapter and then the polymeric muffler body, perhaps premounted on the other unattached (to the exhaust pipe) adapter is slid down the exhaust pipe, and for instance as shown in FIGS. 2A-2C, pushed against the already attached (to the exhaust pipe) adapter. The adapter which is unattached to the exhaust pipe is now attached to the exhaust pipe, as by welding.

As noted above there should be sufficient distance (air gap) between the exhaust pipe and polymeric muffler body so that the polymeric muffler body is not overheated. The distance needed can be determined by trial and error. It can also be modeled using computer programs designed to calculate heat flows. A typical computer program for this purpose is Ansys® CFX, release 11 (obtained from Ansys Inc., Canonsburg, Pa. 15317, USA). Using such a modeling program the needed distance between the exhaust pipe and polymeric muffler body can be computed for any given set of conditions and polymer properties. In some instances the critical hot spot for the polymeric muffler body may be the first and/or second mounting adapter(s) at the point where it is contacting or near to contacting the polymeric muffler body. In that instance the distance between the exhaust pipe and point of contact with the polymeric muffler body of the adapter, and thermal conduction of the adapter itself, may be the critical factors.

If a gasket, o-ring and/or sealant/adhesive is used the material from which it is made should preferably be reasonably stable at the temperatures to which it would be exposed in normal operation. In many instances the highest temperature one of these substances will encounter will be the contact temperature with the first and/or second mounting adapters. Again such temperatures may be determined by the same methods described immediately above for determining the temperatures reached by the polymeric muffler body.

The muffler system described herein may have few parts, and these parts are particularly cheap to make. Assembly and installation are also relatively easy and similar to what is done today with metal mufflers. Polymeric mufflers tend to be more efficient volumetrically than metal mufflers in controlling noise, since polymers tend to dampen noise better than metals, and thus the muffler may be smaller to achieve the same dampening effect. Because of this, and the fact that polymers have a lower density, these mufflers are lighter than traditional metal mufflers, an advantage in many applications, such as motor vehicles, power lawn equipment, and power tools.

What is claimed is:

1. A muffler system, comprising a metal exhaust pipe attached to and passing through a first body mounting adapter, and attached to and passing through a second body mounting adapter; between said first and second mounting adapter said metal exhaust pipe being encased by a polymeric muffler body attached to the said first and second body mounting adapters to provide a muffler interior, said muffler interior having an air gap, said air gap being a space in between said exhaust pipe and said polymeric muffler body in the vicinity of said first body mounting adapter and/or said second body mounting adapter that is filled with air, and said first body mounting adapter and said second mounting adapter hold said polymeric body a distance from said exhaust pipe so that said polymeric muffler body does not suffer significant thermal damage during operation of said muffler system.

2. The muffler system of claim 1 wherein said polymeric muffler body has a length and a cross section and said cross section is constant over the length of the length of the polymeric muffler body.

3. The muffler system of claim 2 wherein said polymeric muffler body cross section has a thickness that varies across said cross section.

4. The muffler system of claim 1 wherein said air gap extends at least 1 cm from said first and second body mounting adapters.

5. The muffler system of claim 1 wherein the muffler interior not occupied by the air gap is partly or fully filled with an insulating material.

6. A process for manufacture of a muffler system, said muffler system comprising, a polymeric muffler body, a metal exhaust pipe, a first body mounting adapter, and a second body mounting adapter, wherein said first body mounting adapter and said second mounting adapter hold said polymeric muffler body a distance from said exhaust pipe so that said polymeric muffler body does not suffer significant thermal damage during operation of said muffler system; comprising:
melt extruding a polymeric material to provide an extrudate; and
cutting the extrudate to provide a length of a polymeric muffler body having a cross section; said cross section being constant over said polymeric muffler body length.

7. The process of claim 6 wherein the extruding provides an extrudate having a cross section that is a portion of the cross section of the polymeric muffler body.

8. The process of claim 7 wherein the extrudate cross section provides two halves of the polymeric muffler body cross section.

9. The process of claim 6 wherein the polymeric muffler body cross section has a thickness that varies across said cross section.
